(19) United States
(12) Patent Application Publication
(10) Pub. No.: US 2010/0165659 A1
(43) Pub. Date: Jul. 1, 2010

(54) PLANAR LIGHT GUIDE AND DISPLAY DEVICE INCLUDING THE SAME

(75) Inventors: Kazutaka ISE, Miyagi-ken (JP); Hideyuki ISHIDA, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/723,535

(22) Filed: Mar. 12, 2010

Related U.S. Application Data
(63) Continuation of application No. PCT/JP2008/067415, filed on Sep. 26, 2008.

(30) Foreign Application Priority Data
Sep. 28, 2007 (JP) 2007-255282

(51) Int. Cl. F21V 7/04

(52) U.S. Cl. 362/606; 362/351

(57) ABSTRACT

A planar light guide includes recesses formed in the upper and lower surfaces thereof. The recesses in the lower surface are perpendicular to the recesses in the upper surface. In a state in which light sources emit light into the planar light guide, when an X-direction driving mechanism is driven and the planar light guide is deformed in the X directions, the recesses in the upper surface are opened, so that the lower surface side can perform surface emission of light. When a Y-direction driving mechanism is driven and the planar light guide is deformed in the Y directions, the recesses in the lower surface are opened, so that the upper surface side can perform surface emission of light. By selectively driving the X-direction driving mechanism or the Y-direction driving mechanism, the position from which light is output, the amount of light, or the direction of light can be changed.

### CLAIM OF PRIORITY

This application is a Continuation of International Application No. PCT/JP2008/067415 filed on Sep. 26, 2008, which claims benefit of the Japanese Patent Application No. 2007-255282 filed on Sep. 28, 2007, which is hereby incorporated by reference.

### BACKGROUND OF THE INVENTION

### Field of the Invention

The present invention relates to a planar light guide for guiding light and performing surface emission of light from a region thereof, and to a display device including the planar light guide. In particular, the present invention relates to a planar light guide capable of controlling the position from which light is output, the amount of light, or the direction of light, and to a display device including the planar light guide.

Japanese Unexamined Patent Application Publication No. 2006-65360 describes a light guide device that can perform surface emission of light from a plurality of positions thereof.

According to Japanese Unexamined Patent Application Publication No. 2006-65360, a light-emitting module is disposed so as to face an end face of a light guide sheet made of a flexible transparent resin, and the light guide sheet includes a plurality of light-emitting regions. The light guide sheet can emit light simultaneously at a plurality of positions with one light-emitting module, and the light-emitting regions can be freely arranged by bending the light guide sheet.

Japanese Unexamined Patent Application Publication No. 2004-361628 describes an illuminated signboard in which a character (word) or the like is formed on a surface of a transparent body in a protrusion/depression pattern and light is emitted from an edge of the transparent body toward the protrusion/depression pattern, so that the character or the like can be displayed.

### SUMMARY OF THE INVENTION

However, the light guide device described in Japanese Unexamined Patent Application Publication No. 2006-65360 emits light always from the same light-emitting regions irrespective of whether the light guide sheet is bent or not while the light-emitting is operation. That is, while the light module is in operation, the positions from which light is output cannot be changed by deforming of the light guide sheet.

The illuminated signboard described in Japanese Unexamined Patent Application Publication No. 2004-361628 can only display a character or the like formed on one surface, so that only a small amount of information can be displayed.

The present invention provides a planar light guide with which the position from which light is output, the amount of light, or the direction of light can be changed in accordance with deformation of the light guide.

The present invention also provides a planar light guide capable of displaying double the amount of information by displaying a character or the like on both sides of the planar light guide.

An aspect of the present invention provides a planar light guide for guiding light and performing surface emission of light, the planar light guide being made of a transparent resin, the planar light guide including a recess for outputting light therefrom, the recess being formed at least in one of first and second surfaces of the light guide, wherein the recess can be changed between an open state, a closed state, and an intermediate state by deforming the light guide, and wherein a position from which light is output, an amount of light, or a direction of light is changed in accordance with the deformation.

The planar light guide can control, in accordance with deformation of the light guide, the position from which light is output, that is, the position at which surface emission of light is performed, the amount of light, or the direction of light. Therefore, various representations can be performed.

Before the light guide is deformed, the recess is in a closed state. When the light guide is deformed, the recess is formed at positions corresponding to the positions at which the light guide is deformed, so that the positions from which light is output, the amount of light, or the direction of light can be controllably changed in a stepwise manner.

It is preferable the position from which light is output, the amount of light, or the direction of light, be changed in accordance with the difference between a tensile force applied in a direction parallel to one of the first and second surfaces and a compressive force applied in the direction parallel to the other one of the first and second surfaces. For example, it is preferable that the difference in the tensile force and the compressive force be generated by pulling at least one of ends of the light guide or by bending the light guide.

In this case, the light guide is controlled with a simple structure because a bending moment can be easily applied to the light guide.

It is preferable that the depth dimension of the recess be smaller than the thickness dimension of the light guide. For example, it is preferable that the recess be formed as a plurality of slits.

In this case, the planar light guide can be formed with a simple structure.

It is preferable that the recess be formed in the first and second surfaces of the light guide, and a longitudinal dimension of the recess formed in the first surface and a longitudinal dimension of the recess formed in the second surface extend perpendicular to each other.

In this case, a force that deforms one of the first and second surfaces is prevented from substantially affecting the other one of the first and second surfaces. Therefore, for example, the lower surface is prevented from performing surface emission of light when the upper surface performs surface emission of light.

It is preferable that the longitudinal dimension of the recess formed in an end portion of the light guide be different from the longitudinal dimension of the recess formed in a middle portion of the light guide. Moreover, it is preferable that the depth dimension of the recess formed in an end portion of the light guide be different from the depth dimension of the recess formed in a middle portion of the light guide.

In this case, the entirety of the light guide can uniformly emit light.

The light guide may include a plurality of block pieces, the block pieces being connected to each other with a transparent elastic member, and the recess may be formed between adjacent block pieces.

In this case, the position at which the planar light guide performs surface emission of light can be selectively deformed.

Another aspect of the present invention provides a display device including the planar light guide, a light source for providing light to the light guide, and a reflecting surface disposed at a position facing one of the first and second surfaces of the light guide, the recess not being formed in the one of the first and second surfaces.

Still another aspect of the present invention provides a display device including the planar light guide, a first light source for providing light to the light guide, and a second light source disposed at a position facing one of the first and second surfaces of the light guide, the recess not being formed in the one of the first and second surfaces.

In the display device, a character, a figure, a symbol, or a pattern may be formed by the recess on the first and second surfaces of the light guide.

In this case, characters or the like formed on both sides of the light guide can be seen from one side, so that double the amount of information can be displayed.

### BRIEF DESCRIPTION OF THE DRAWINGS

FIGS. 1A to 1D illustrate a display device including a planar light guide according to a first embodiment of the present invention, FIG. 1A is a plan view showing the upper surface side of the planar light guide, FIG. 1B is a sectional view taken along line IB-IB parallel to the X axis in FIG. 1A, FIG. 1C is a bottom view showing the lower surface side of the planar light guide, and FIG. 1D is a sectional view taken along line ID-ID parallel to the X axis in FIG. 1C;

FIGS. 2A to 2C illustrate a state in which tensile forces in the X directions are applied to the planar light guide, FIG. 2A is a plan view showing the upper surface side of the planar light guide, FIG. 2B is a sectional view of FIG. 2A, and FIG. 2C is a bottom view showing the lower surface side of the planar light guide;

FIGS. 3A to 3C illustrate a state in which tensile forces in the Y directions are applied to the planar light guide, FIG. 3A is a plan view showing the upper surface side of the planar light guide, FIG. 3B is a sectional view of FIG. 3A, and FIG. 3C is a bottom view showing the lower surface side of the planar light guide;

FIG. 4A is a plan view illustrating an example of recesses formed in the upper surface of a sheet-shaped light guide, and FIG. 4B is a bottom view of an example of recesses formed in the lower surface of the sheet-shaped light guide;

FIG. 5 is a plan view of a display device according to a second embodiment of the present invention;

FIGS. 6A to 6C illustrate an application of the display device of the second embodiment, FIG. 6A is a plan view showing the upper surface side of the planar light guide, FIG. 6B is a sectional view of FIG. 6A, and FIG. 6C is a bottom view showing the lower surface side of the planar light guide;

FIGS. 7A to 7C illustrate a display device according to a third embodiment, FIG. 7A is a plan view showing the upper surface side, FIG. 7B is a sectional view of FIG. 7A, and FIG. 7C is a bottom view showing the lower surface side;

FIGS. 8A and 8B illustrate a modification of the third embodiment, FIG. 8A is a plan view showing the upper surface side, FIG. 8B is a bottom view showing the lower surface side;

FIGS. 9A to 9C illustrate a display device according to a fourth embodiment of the present invention, FIG. 9A is a plan view showing the upper surface side of the planar light guide, FIG. 9B is a sectional view taken along line IXB-IXB in FIG. 9A, and FIG. 9C is a sectional view taken along line IXC-IXC in FIG. 9A;

FIGS. 10A to 10C illustrate a display device according to a fifth embodiment of the present invention, FIG. 10A is a plan view showing the upper surface side of the planar light guide, FIG. 10B is a sectional view taken along line XB-XB in FIG. 10A, and FIG. 10C is a sectional view similar to FIG. 10B illustrating a state in which the planar light guide is in operation; and

FIGS. 11A to 11C illustrate a display device according to a six embodiment of the present invention, FIG. 11A is a plan view showing the upper surface side of the planar light guide, FIG. 11B is a sectional view taken along line XIB-XIB in FIG. 11A, and FIG. 11C is a sectional view similar to FIG. 11B illustrating a state in which the planar light guide is in operation.

### DESCRIPTION OF THE PREFERRED EMBODIMENTS

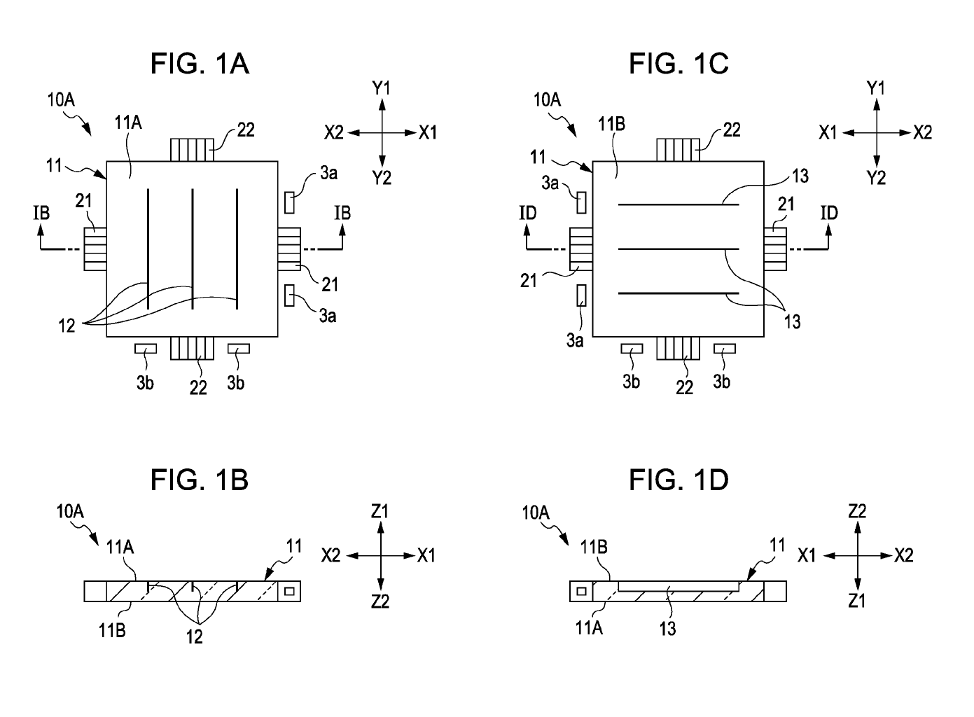

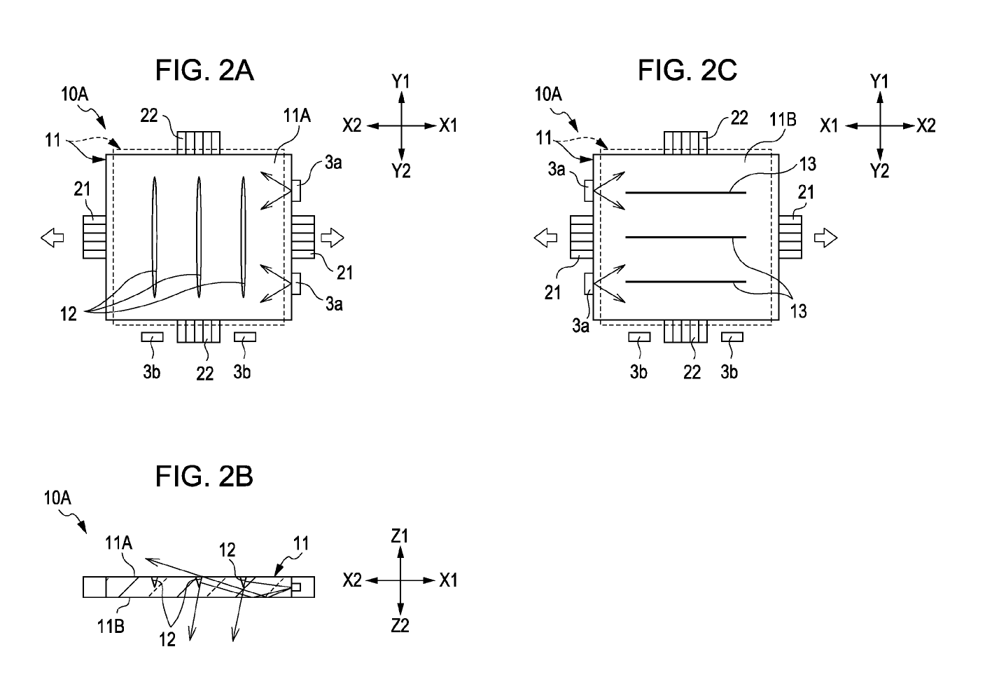

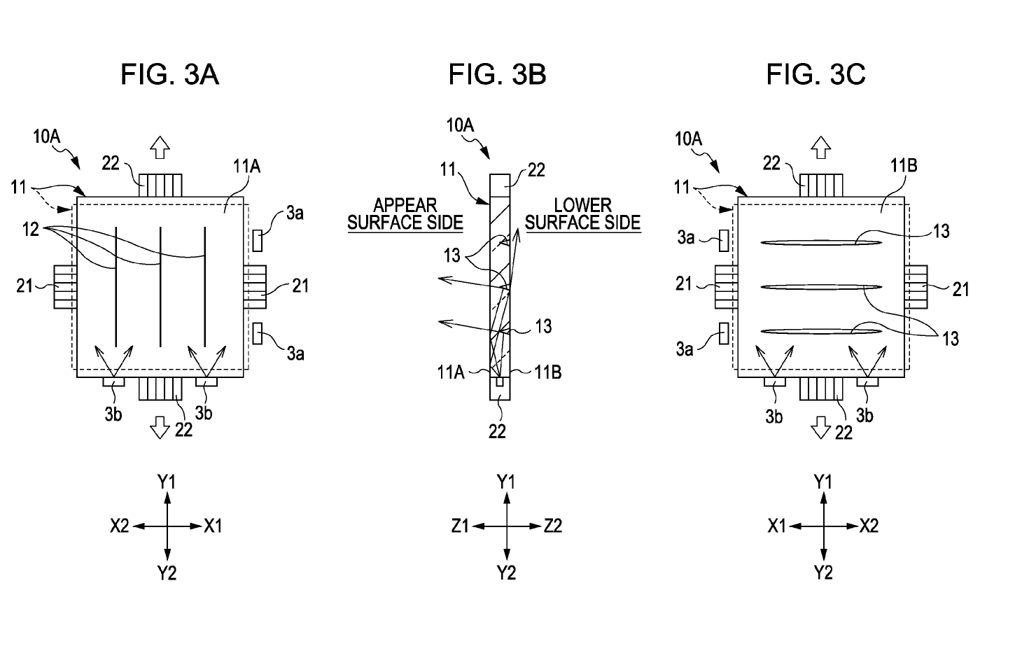

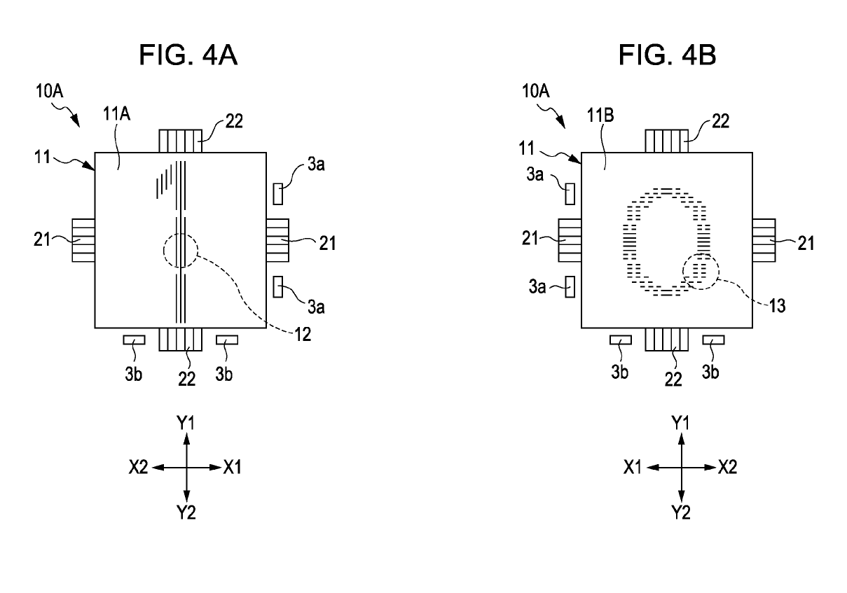

FIGS. 1A to 1D illustrate a display device including a planar light guide according to a first embodiment of the present invention, FIG. 1A is a plan view showing the upper surface side of the planar light guide, FIG. 1B is a sectional view taken along line IB-IB parallel to the X axis in FIG. 1A, FIG. 1C is a bottom view showing the lower surface side of the planar light guide, and FIG. 1D is a sectional view taken along line ID-ID parallel to the X axis in FIG. 1C. FIGS. 2A to 2C illustrate a state in which tensile forces in the X directions are applied to the planar light guide, FIG. 2A is a plan view showing the upper surface side of the planar light guide, FIG. 2B is a sectional view of FIG. 2A, and FIG. 2C is a bottom view showing the lower surface side of the planar light guide. FIGS. 3A to 3C illustrate a state in which tensile forces in the Y directions are applied to the planar light guide, FIG. 3A is a plan view showing the upper surface side of the planar light guide, FIG. 3B is a sectional view of FIG. 3A, and FIG. 3C is a bottom view showing the lower surface side of the planar light guide. FIG. 4A is a plan view illustrating an example of recesses formed in the upper surface of a sheet-shaped light guide, and FIG. 4B is a bottom view of an example of recesses formed in the lower surface of the sheet-shaped light guide.

A planar light guide according to the present invention is used, for example, in a display device that displays a character, a figure, a symbol, or the like, such as an illuminated signboard or an electronic signboard for displaying the present location or a destination. The planar light guide can also be used as an illumination device for the keyboard of a mobile phone.

As illustrated in FIGS. 1A to 1C, a display device 10A includes a sheet-shaped light guide (planar light guide) 11 made of elastic transparent resin. As the material of the planar light guide 11, polyurethane, silicone, or the like can be used.

As illustrated in FIGS. 1A and 1B, a plurality of (three in FIG. 1A) recesses 12 are formed in an upper surface 11A of the planar light guide 11. The recesses 12 have a longitudinal dimension that extends in the Y directions and a depth dimension that extends in the Z2 direction from the upper surface 11A. The recesses 12 are, for example, formed as slits. The depth dimension of the slits is about half the thickness dimension of the planar light guide 11. The recesses 12 are in closed states in a normal state in which a tensile force is not being applied to the planar light guide 11 in the directions perpendicular to the longitudinal direction of the recesses 12 (the X directions).

As illustrated in FIGS. 1C and 1D, a plurality of (three in FIG. 1C) recesses 13 are formed in a lower surface 11B of the planar light guide 11. The recesses 13 have a longitudinal dimension that extends in the X directions and a depth dimension that extends in the Z1 direction from the upper surface 11B. The recesses 13 are also formed as slits, and the depth dimension of the slits is about half the thickness dimension of the planar light guide 11. The recesses 13 are in closed states in a normal state in which a tensile force is not being applied to the planar light guide 11 in the direction perpendicular to the longitudinal direction of the recesses 13 (the Y directions).

Before the planar light guide 11 is deformed, there are almost no gaps in the recesses 12 and 13, and side surfaces of the recesses 12 and 13 are substantially parallel to each other. Therefore, light that is incident on the recesses 12 or the recesses 13 can substantially straightly pass through the recesses 12 or the recesses 13.

A pair of X-direction driving mechanisms 21 are disposed at ends of the planar light guide 11 in the X directions, and a pair of Y-direction driving mechanisms 22 are disposed at ends of the planar light guide 11 in the Y directions. The X-direction driving mechanisms 21 include actuators that apply tensile forces in the X directions to the ends of the planar light guide 11 in the X directions, and the Y-direction driving mechanisms 22 include actuators that apply tensile forces in the Y directions to the ends of the planar light guide 11 in the Y directions. The X-direction driving mechanisms 21 and the Y-direction driving mechanisms 22 may include a variety of force-applying means, such as electrostatic actuators, electromagnetic actuators, and piezoelectric actuators. However, the force-applying means are not limited to such actuators.

Near the X-direction driving mechanism 21 disposed on the X1 side, light sources 3a are disposed at positions on virtual lines that are perpendicular to the longitudinal direction of the recesses 12. Likewise, near the Y-direction driving mechanism 22 disposed on the Y2 side, light sources 3b are disposed at positions on virtual lines that are perpendicular to the longitudinal direction of the recesses 13. Light emitted from the light sources 3a enters the planar light guide 11 through an end face on the X1 side, and light emitted from the light sources 3b enters the planar light guide 11 through an end face on the Y2 side. The light that has entered the planar light guide 11 through the end faces travels in directions away from the light sources 3a and 3b while repeatedly undergoing total internal reflection between the upper surface 11A and the lower surface 11B of the planar light guide 11.

Next, an operation of the display device 10A will be described. When the X-direction driving mechanisms 21 are driven, at least one of the X-direction driving mechanisms disposed on the X1 and X2 sides is driven and pulls the planar light guide 11 in the X directions. At this time, the planar light guide 11 is stretched in the X directions. As a result, as illustrated in FIG. 2A, the recesses 12 on the upper surface 11A side, which have a longitudinal dimension that extends perpendicular to the direction in which the planar light guide 11 is pulled, are deformed so that the open angles of the recesses 12 increase. As illustrated in FIG. 2C, the recesses 13 on the lower surface 11B side, which have a longitudinal dimension that extends parallel to the direction in which the planar light guide 11 is pulled, are almost unchanged and continue to be in closed states.

At this time, as illustrated in FIG. 2B, almost all light is reflected by side surfaces of the recesses 12 in the Z2 direction toward the lower surface 11B side. The light is incident on the lower surface 11B at an angle of incidence smaller than the critical angle of total internal reflection, and the light is emitted to the outside from the lower surface 11B of the planar light guide 11. Thus, the lower surface 11B side of the planar light guide 11 can perform surface emission of light. When the display device 10A is viewed from the Z2 direction, three lines of light extending in the Y directions can be seen.

The same applies to the Y-direction driving mechanisms 22. As illustrated in FIG. 3C, when the Y-direction driving mechanisms 22 are driven, the planar light guide 11 is pulled in the Y directions. The recesses 13 on the lower surface 11B side, which have a longitudinal dimension that extends perpendicular to the direction in which the planar light guide 11 is pulled, are deformed so that the open angles of the recesses 13 increase. As illustrated in FIG. 3A, the recesses 12 on the upper surface 11A side, which have a longitudinal dimension extending parallel to the direction in which the planar light guide 11 is pulled, continue to be in closed states. Therefore, in this case, the upper surface 11A of the planar light guide 11 can perform surface emission of light. When the display device 10A is viewed from the Z1 direction, which is from the upper surface 11A side, three lines of light extending in the X directions can be seen.

Therefore, as illustrated in FIGS. 4A and 4B, for example, when a character “1” is formed on the upper surface 11A of the planar light guide 11 with the recesses 12 and a character “0” is formed on the lower surface 11B with the recesses 13, the following effect is produced.

In a stationary state in which the X-direction driving mechanisms 21 and the Y-direction driving mechanisms 22 are not being driven, the recesses 12 and 13 are in the closed states. Therefore, the characters cannot be clearly seen on the upper surface 11A and the lower surface 11B of the display device 10A.

When the X-direction driving mechanisms 21 are driven, the recesses 12 on the upper surface 11A side are deformed to be in the open states, so that the character “1” is clearly displayed on the lower side. Likewise, when the Y-direction driving mechanisms 22 are driven, the recesses 13 on the lower surface 11B side are deformed to be in open states, so that the character “0” is clearly displayed on the upper side.

Thus, the display device 10A according to the first embodiment emits light from a surface opposite the surface in which the recesses 12 or the recesses 13 are formed. Therefore, a character or the like formed on the lower surface 11B side can be displayed on the upper surface 11A, and characters or the like formed on the upper surface 11A side can be displayed on the lower surface 11B.

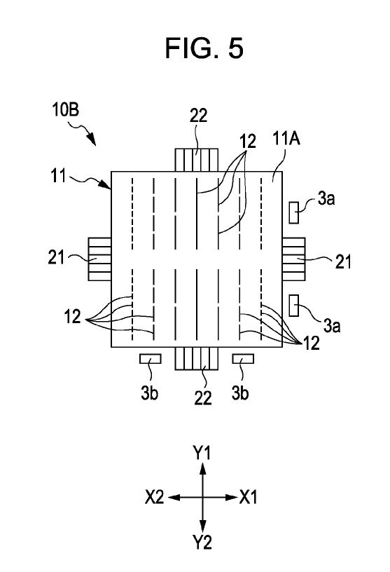

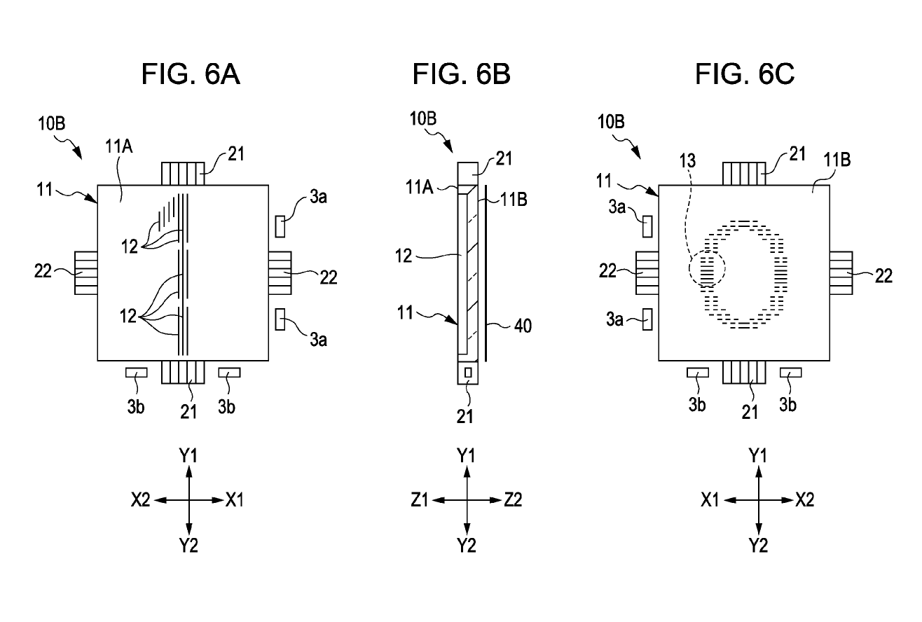

Next, a second embodiment of the present invention will be described. FIG. 5 is a plan view of a display device according to a second embodiment of the present invention. FIGS. 6A to 6C illustrate an application of the display device of the second embodiment, FIG. 6A is a plan view showing the upper surface side of the planar light guide, FIG. 6B is a sectional view of FIG. 6A, and FIG. 6C is a bottom view showing the lower surface side of the planar light guide.

As illustrated in FIG. 5, a display device 10B of the second embodiment is different from that of the first embodiment in that the longitudinal dimensions of the recesses 12 formed in the upper surface 11A of the planar light guide 11 differ depending on the positions of the recesses 12. That is, in the upper surface 11A that is to be stretched in the X directions, the recesses 12 are formed in such a manner that the longitudinal dimensions of the recesses 12 in the Y directions become larger the closer the recesses 12 are to the center of the planar light guide 11 and the longitudinal dimensions become smaller the farther the recesses 12 are from the center toward the ends in the X directions. The same applies to the recesses 13 that are formed in the lower surface 11B of the planar light guide 11. The recesses 13 are formed in such a manner that the longitudinal dimensions of the recesses 13 in the X directions become larger the closer the recesses 13 are to the center of the planar light guide 11 and the longitudinal dimensions become smaller the farther the recesses 13 are from the center toward the ends in the Y directions (not shown).

When a tensile force is applied to the planar light guide 11 in one direction by using either of the X-direction driving mechanisms 21 and the Y-direction driving mechanisms 22 as described above, it is difficult to uniformly apply tensile forces to all the recesses 12 and 13 in the planar light guide 11. In particular, the tensile forces applied to the recesses tend to differ between the middle portion and the end portions of the planar light guide 11. Therefore, if the longitudinal dimensions of the recesses 12 are the same, the recesses 12 in the end portions of the planar light guide 11 that are close to the X-direction driving mechanisms 21 open to a greater degree, and the recesses 12 in the middle portion of the planar light guide 11 open to a lesser degree. As a result, light cannot be uniformly emitted from the entire surface of the planar light guide 11.

As described above, by changing the longitudinal dimensions of the recesses 12 in a stepwise manner between the middle portion and the end portions of the planar light guide 11 in such a manner that the longitudinal dimensions are smaller at the end portions and larger in the middle portion, light can be uniformly emitted from the entire surface of the planar light guide 11 even if the open angles of the recesses 12 differ depending on the positions of the recesses 12.

Referring to FIGS. 6A to 6C, as with the case of FIGS. 4A and 4B, a case in which the character “1” is formed on the upper surface 11A side of the planar light guide 11 with the recesses 12 and the character “0” is formed on the lower surface 11B side with the recesses 13 will be described. In FIG. 6A, the character “1” is mainly formed with the recesses 12 that have large longitudinal dimensions because almost all parts of the character “1” are disposed in the middle portion of the upper surface 11A. On the other hand, the character “0” formed on the lower surface side is disposed so as to straddle the middle portion and the end portions. Therefore, parts of the character “0” in the upper and lower end portions in the Y directions are formed with the recesses 13 that have small longitudinal dimensions, and parts of the character “0” in the middle portion are formed with the recesses 13 that have large longitudinal dimensions.

In this case, when the X-direction driving mechanisms 21 are driven and the planar light guide 11 is pulled in the X directions, the character “1” can be uniformly displayed on the lower surface 11B side of the planar light guide 11. Likewise, when the Y-direction driving mechanisms 22 are driven and the planar light guide 11 is pulled in the Y directions, the character “0” can be uniformly displayed on the upper surface 11A side of the planar light guide 11.

As illustrated in FIG. 6B, in this case, a dispersion reflecting surface 40, for example, may be disposed at a position facing the lower surface 11B of the planar light guide 11. With this structure, light that is emitted from the lower surface 11B is reflected by the dispersion reflecting surface 40 and reenters the planar light guide 11 through the lower surface 11B, and can be emitted again from the upper surface 11A to the outside of the planar light guide 11. Thus, by driving the X-direction driving mechanisms 21, the character “1” can be displayed on the upper surface 11A side of the planar light guide 11.

Therefore, a character or the like formed on the upper surface 11A can be displayed on the upper surface 11A side of the planar light guide 11 opposite the lower surface 11B side on which the dispersion reflecting surface 40 is disposed. Thus, the display device 10B displays the character “1”, which is formed on the upper surface 11A, when the X-direction driving mechanisms 21 are driven, and displays the character “0”, which is formed on the lower surface 11B, when the Y-direction driving mechanisms 22 are driven.

Therefore, characters formed on the upper and lower surfaces of the planar light guide 11 can be seen from the upper surface 11A side of the display device 10B. As a result, the display device 10B can display a larger amount of information than existing display devices.

The dispersion reflecting surface 40 can be formed, for example, by using a fine protrusion/depression pattern or a diffusion sheet.

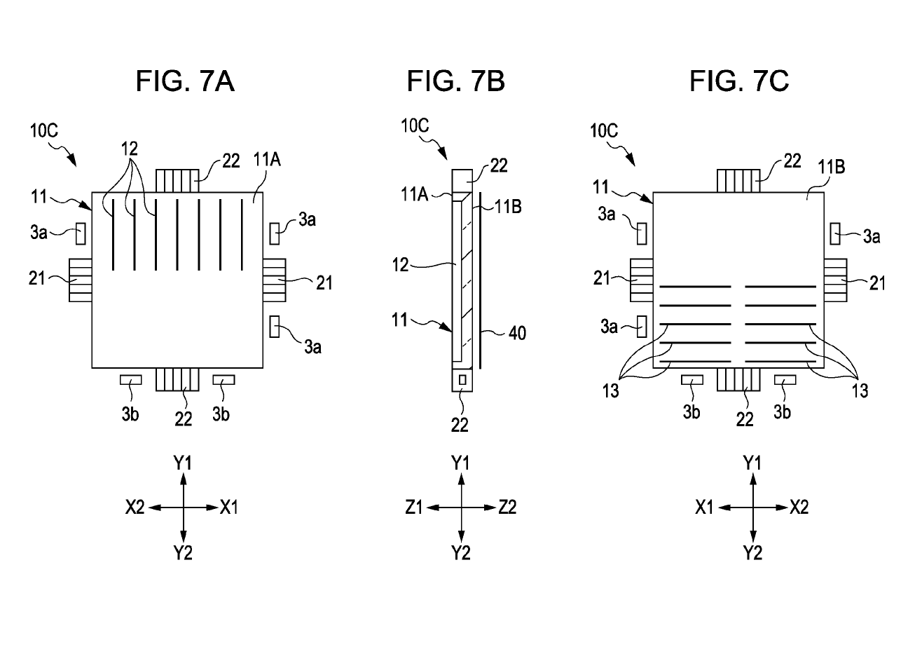

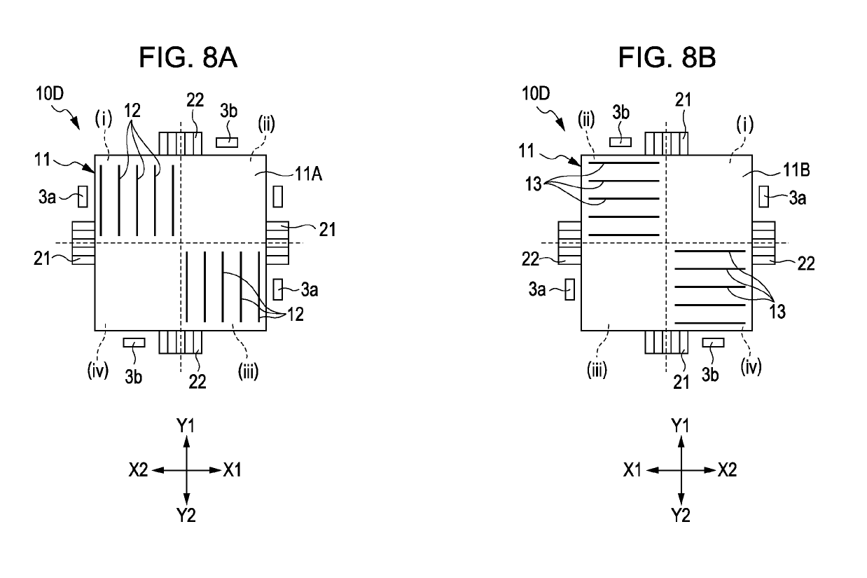

FIGS. 7A to 7C illustrate a display device according to a third embodiment, FIG. 7A is a plan view showing the upper surface side, FIG. 7B is a sectional view of FIG. 7A, and FIG. 7C is a bottom view showing the lower surface side. FIGS. 8A and 8B illustrate a modification of the third embodiment, FIG. 8A is a plan view showing the upper surface side, FIG. 8B is a bottom view showing the lower surface side.

A display device 10C of the third embodiment illustrated in FIGS. 7A to 7C is different from the display devices of the first and second embodiments in the following respects. The recesses 12 are formed only in the front end portion of the upper surface 11A on the Y1 side, and the rear end portion of the upper surface 11A on the Y2 side is a flat surface in which the recesses 12 are not formed. Likewise, the recesses 13 are formed only in the rear end portion of the lower surface 11B on the Y2 side, and the front end portion of the lower surface 11B on the Y1 side is a flat surface in which the recesses 13 are not formed. That is, the recesses 12 on the upper surface 11A side of the planar light guide 11 and the recesses 13 on the lower surface 11B side of the planar light guide 11 are disposed in such a manner that the recesses 12 and the recesses 13 do not overlap each other.

The light sources 3a at the ends of the planar light guide 11 in the X directions are provided for the recesses 12 that are formed in the front end portion. The light sources 3b at the ends of the planar light guide 11 in the Y2 direction are provided for the recesses 13 that are formed in the rear end portion. The third embodiment is similar in other respects to the second embodiment, and the dispersion reflecting surface 40 is disposed on the lower surface 11B.

With the display device 10C of the third embodiment, when the X-direction driving mechanisms 21 are driven, only the front end portion of the display device 10C on the Y1 side emits light toward the lower surface 11B side. When the Y-direction driving mechanisms 22 are driven, only the rear end portion of the display device 10C on the Y2 side emits light toward the upper surface 11A side. That is, the display device 10C can provide partial illumination.

In the third embodiment, the recesses 12 and 13 are shown by only a plurality of lines. However, as described above, a character, a figure, a symbol, or a pattern may be formed with the recesses 12 and 13.

In this case, when the X-direction driving mechanisms 21 are driven, light representing a character or the like formed on the upper surface 11A is reflected by the dispersion reflecting surface 40 and the character or the like is displayed on the upper surface 11A side. When the Y-direction driving mechanisms 22 are driven, a character or the like formed on the lower surface 11B can be directly displayed on the upper surface 11A side. Moreover, the character or the like formed on the lower surface 11B side can be clearly displayed, because the character or the like formed on the front end portion of the upper surface 11A side and the character or the like formed on the rear end portion of the lower surface 11B side do not overlap each other.

Thus, with the present invention, light can be selectively output by driving the X-direction driving mechanisms 21 or the Y-direction driving mechanisms 22.

When the X-direction driving mechanisms 21 and the Y-direction driving mechanisms 22 are simultaneously driven and the planar light guide 11 is simultaneously pulled in the X and Y directions, the character or the like formed in the front end portion of the upper surface 11A and the character or the like formed in the rear end portion of the lower surface 11B can be simultaneously seen from one direction. Therefore, this display device can display a larger amount of information than existing display devices.

In the embodiments described above, regions of the upper and lower sides of the planar light guide 11 are divided into the front end portion of the upper surface 11A on the Y1 side and the rear end portion of the lower surface 11B on the Y2 side. However, the present invention is not limited thereto, and the regions of the upper and lower sides can be disposed in any manner as long as the regions do not overlap each other.

For example, as in the modification illustrated in FIGS. 8A and 8B, the planar light guide 11 may be divided into four regions (i), (ii), (iii), and (iv). The recesses 12 may be formed in the upper surface 11A so as to extend in the Y directions in the regions (i) and (iii) that are at diagonal positions, and the recesses 13 may be formed in the lower surface 11B so as to extend in the X directions in the regions (ii) and (iv) that do not overlap the regions (i) and (iii).

In the modification of the third embodiment illustrated in FIGS. 8A and 8B, when the X-direction driving mechanisms 21 of a display device 10D are driven, the recesses 12 are opened, and the regions (i) and (iii) can simultaneously perform surface emission of light. When the Y-direction driving mechanisms 22 are driven, the recesses 13 are opened and the regions (ii) and (iv) can simultaneously perform surface emission of light. When the X-direction driving mechanisms 21 and the Y-direction driving mechanisms 22 are simultaneously driven, all four regions (i), (ii), (iii), and (iv) can simultaneously perform surface emission of light.

Also in this case, the dispersion reflecting surface 40 may be disposed at a position facing the lower surface 11B. When the X-direction driving mechanisms 21 and the Y-direction driving mechanisms 22 are simultaneously driven and the planar light guide 11 is simultaneously pulled in the X directions and in the Y directions, characters or the like formed in the four regions (i), (ii), (iii), and (iv) can be simultaneously seen from one direction. Therefore, the display device of the modification can display a larger amount of information than existing display devices.

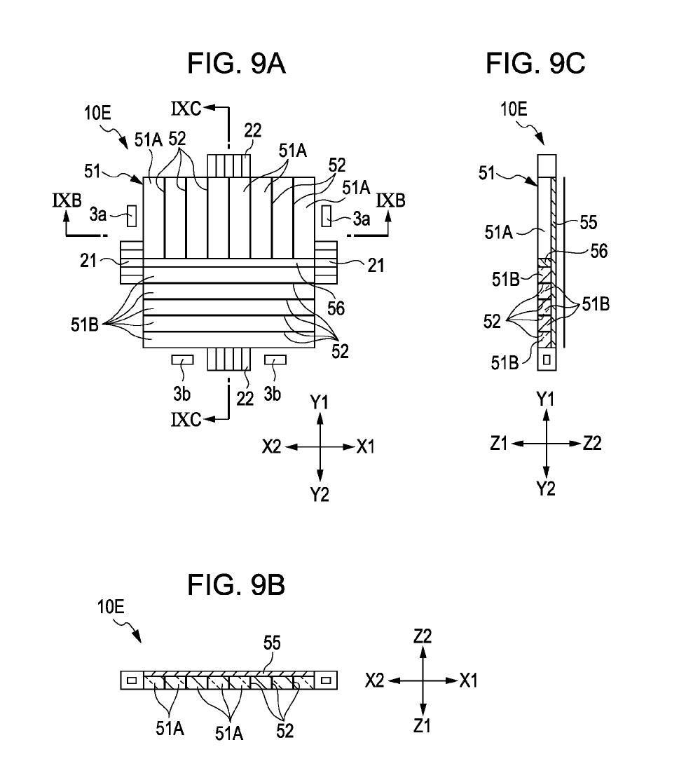

FIGS. 9A to 9C illustrate a display device according to a fourth embodiment of the present invention, FIG. 9A is a plan view showing the upper surface side of the planar light guide, FIG. 9B is a sectional view taken along line IXB-IXB in FIG. 9A, and FIG. 9C is a sectional view taken along line IXC-IXC in FIG. 9A.

A display device 10E of the fourth embodiment is different from those of the embodiments described above in that the display device 10E does not include an elastic sheet-shaped light guide. Instead, the display device 10E includes a planar light guide 51 including a plurality of block pieces 51A that are transparent and comparatively rigid.

The block pieces 51A are plate-shaped (bar-shaped). The block pieces 51A are disposed on a transparent planar elastomer (elastic member) 55. The block pieces 51A are regularly arranged in the X directions perpendicular to the Y directions so that the longitudinal dimensions of the block pieces 51A extend in the Y directions. In this state, the block pieces 51A are connected to each other using a transparent adhesive.

In the planar light 51 illustrated in FIG. 9A, in the front end portion on the Y1 side, the block pieces 51A are arranged in the X directions and connected to each other, and, in the rear end portion on the Y2 side, block pieces 51B are arranged in the Y directions and connected to each other. The block pieces 51A arranged in the X directions are connected to the block pieces 51B arranged in the Y directions with an elastomer (elastic member) 56 disposed therebetween. The block pieces 51A and 51B constitute the planar light guide 51 having a square shape.

Only the lower surfaces of the block pieces 51A on the Z2 side are bonded to the elastomer 55. The upper surfaces of the block pieces 51A on the Z1 side are in free states. Thus, in the embodiment, recesses 52 are formed at the boundaries between adjacent block pieces 51A and at the boundaries between adjacent block pieces 51B.

The X-direction driving mechanisms 21 are disposed at ends of the display device 10D in the X directions, and the Y-direction driving mechanisms 22 are disposed at ends of the display device 10D in the Y directions. In the front end portion of the display device 10D on the Y1 side, the light sources 3a are disposed at ends in the X directions. In the rear end portion of the display device 10D on the Y2 side, the light sources 3b are disposed on both sides of the Y-direction driving mechanism 22.

Light emitted from the light sources 3a and 3b enters the block pieces 51A and 51B through the side surfaces of the block pieces 51A and 51B facing the light sources. Before the planar light guide 51 is deformed, the boundaries between adjacent square-shaped block pieces 51A are in contact states. Therefore, the recesses 52 are not clearly formed between adjacent block pieces 51A, and most of light that exits from a surface of one of the block pieces 51A directly enters adjacent one of the block pieces 51A. The light propagates through the planar light guide 51 while repeatedly undergoing total internal reflection between the upper and lower surfaces of the block pieces 51A.

When the X-direction driving mechanisms 21 or the Y-direction driving mechanisms 22 are driven, and the planar light guide 51 is pulled in the X directions or in the Y directions or bent, for example, a tensile force is applied to the elastomer 55 side on the lower surface and a compressive force is applied to the free end side on the upper surface. At this time, discrepancy occurs between the upper surfaces and the lower surfaces of the block pieces 51A owing to the tensile force and the compressive force, so that the open angles of the recesses 52 between the block pieces 51A increase. Therefore, most of light is reflected by side surfaces of the block pieces 51A, which form the recesses 52, in the Z2 direction toward the lower surface side. The light is incident on the lower surfaces of the block pieces 51A at an angle of incidence smaller than the critical angle of total internal reflection, and the light is output from the lower surfaces of the block pieces 51A that are connected to each other.

Therefore, when the X-direction driving mechanisms 21 are driven as described above, only a region in the front end portion on the Y1 side can perform surface emission of light, and, when the Y-direction driving mechanisms 22 are driven, only a region in the rear end portion on the Y2 side can perform surface emission of light.

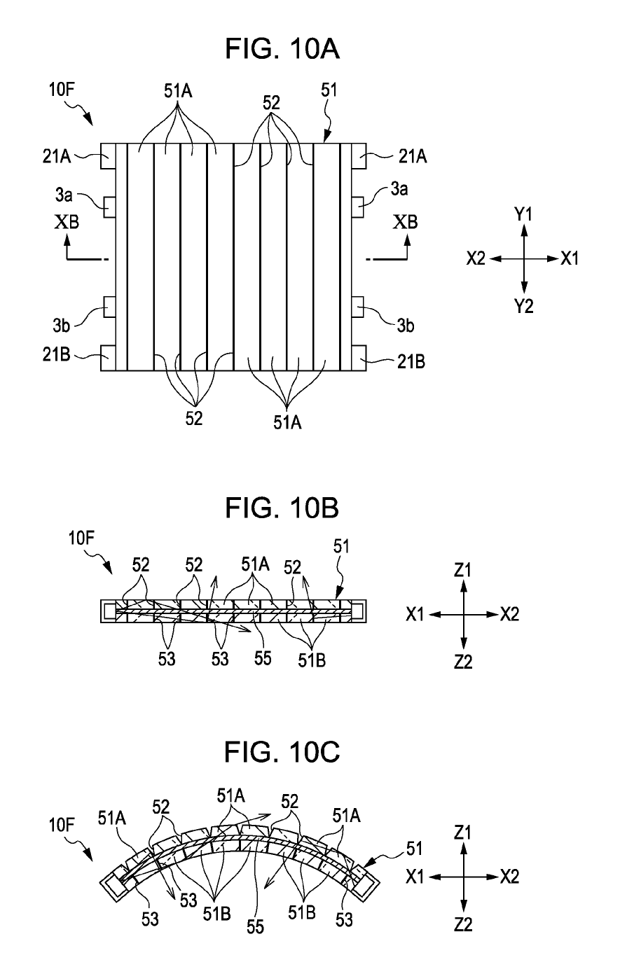

FIGS. 10A to 10C illustrate a display device according to a fifth embodiment of the present invention, FIG. 10A is a plan view showing the upper surface side of the planar light guide, FIG. 10B is a sectional view taken along line XB-XB in FIG. 10A, and FIG. 10C is a sectional view similar to FIG. 10B illustrating a state in which the planar light guide is in operation.

In the embodiment illustrated in FIGS. 10A to 10C, block pieces similar to those of the fourth embodiment are used. That is, a display device 10F of the fifth embodiment includes a planar light guide 51 configured as follows. Block pieces 51A are arranged on the upper surface side in the X directions in such a manner that the longitudinal dimensions of the block pieces 51A extend in the Y directions perpendicular to the X directions. Block pieces 51B as many as the block pieces 51A are arranged on the lower surface side in the X directions in such a manner that the longitudinal dimensions of the block pieces 51B extend in the Y directions. The block pieces 51A on the upper surface side and the block pieces 51B on the lower surface side are bonded to each other with an elastomer (elastic member) 55, which is made of a transparent resin film or the like, therebetween. Each of the block pieces 51A in upper positions faces a corresponding one of the block pieces 51B in lower positions with the elastomer 55 therebetween. The entirety of the planar light guide 51 has a jalousie-like shape. In the display device 10F, the block pieces 51A and the block pieces 51B are joined together in pairs with the elastomer 55 therebetween, and the display device 10F can be deformed at each pair of the block pieces.

First X-direction driving mechanisms 21A and second X-direction driving mechanisms 21B, which are similar to the driving mechanisms described above, are disposed at ends of the display device 10F in the X directions. The first X-direction driving mechanisms 21A are disposed at ends on Y1 side, and the second X-direction driving mechanisms 21B are disposed on Y2 side. Light sources 3a and light sources 3b are disposed at ends of the display device 10F in the X directions and between the first X-direction driving mechanisms 21A and second drive mechanisms 21B. The light sources 3a are disposed so as to face the block pieces 51A disposed at ends on the upper surface side. Likewise, the light sources 3b are disposed so as to face the block pieces 51B disposed at ends on the lower surface side.

On the upper surface side of the planar light guide 51, recesses 52 are formed between adjacent block pieces 51A. On the lower surface side of the planar light guide 51, recesses 53 are formed between adjacent block pieces 51B.

As illustrated in FIG. 10B, light emitted from the light sources 3a enters the planar light guide 51 through the block pieces 51A that are disposed on the upper surface side and at ends in the X directions. Likewise, light emitted from the light sources 3b enters the planar light guide 51 through the block pieces 51B disposed on the lower surface side and at ends in the X directions. The light that has entered the block pieces 51A and the block pieces 51B propagates through the planar light guide 51 while repeatedly undergoing total internal reflection between upper surfaces of the block pieces 51A and the lower surfaces of the block pieces 51B. At this time, the light passes through the transparent elastomer 55 in the thickness direction.

As illustrated in FIG. 10C, when the first X-direction driving mechanisms 21A and the second X-direction driving mechanisms 21B are driven, and, for example, a tensile force is applied to the block pieces 51A on the upper surface side and a compressive force is applied to the block pieces 51B on the lower surface side, the middle portion of the planar light guide 51 is bent so that the middle portion protrudes upward relative to the ends in the X directions (becomes upwardly convex in the Z1 direction).

At this time, recesses 52 between the block pieces 51A on the upper surface side enter open states, and recesses 53 between the block pieces 51A on the lower surface side continue to be in closed states. Therefore, the amount of light that is emitted downward through the lower surface of the planar light guide 51 is larger than the amount of light that is emitted upward through the upper surface of the planar light guide 51. Therefore, the display device 10F can perform surface emission of light so that the lower side emits more light than the upper side.

When a compressive force is applied to the block pieces 51A on the upper surface side and a tensile force is applied to the block pieces 51B on the lower surface side, the planar light guide 51 is bent so that the middle portion of the planar light guide 51 protrudes downward relative to the ends in the X directions (becomes downwardly convex in the Z2 direction). At this time, the display device 10F can perform surface emission of light so that the upper side emits more light than the lower side.

With the display device 10F of the fifth embodiment, by adjusting the driving forces of the first X-direction driving mechanisms 21A and the second drive mechanisms 21B, a position at which the planar light guide 51 is bent can be changed, whereby the position at which surface emission of light occurs can be controlled. For example, by gradually moving the position at which the planar light guide 51 is deformed from an end in the X1 direction toward an end in the X2 direction, the position at which surface emission of light occurs can be gradually moved from the end in the X1 direction toward the end in the X2 direction.

It is not necessary that the display device 10F of the fifth embodiment be deformed by using the first X-direction driving mechanisms 21A and the second X-direction driving mechanisms 21. For example, the planar light guide 51 can be deformed by a force that is directly or indirectly applied by a user, and the direction, the position, and the amount of light of the surface emission of light can be changed in accordance with such deformation.

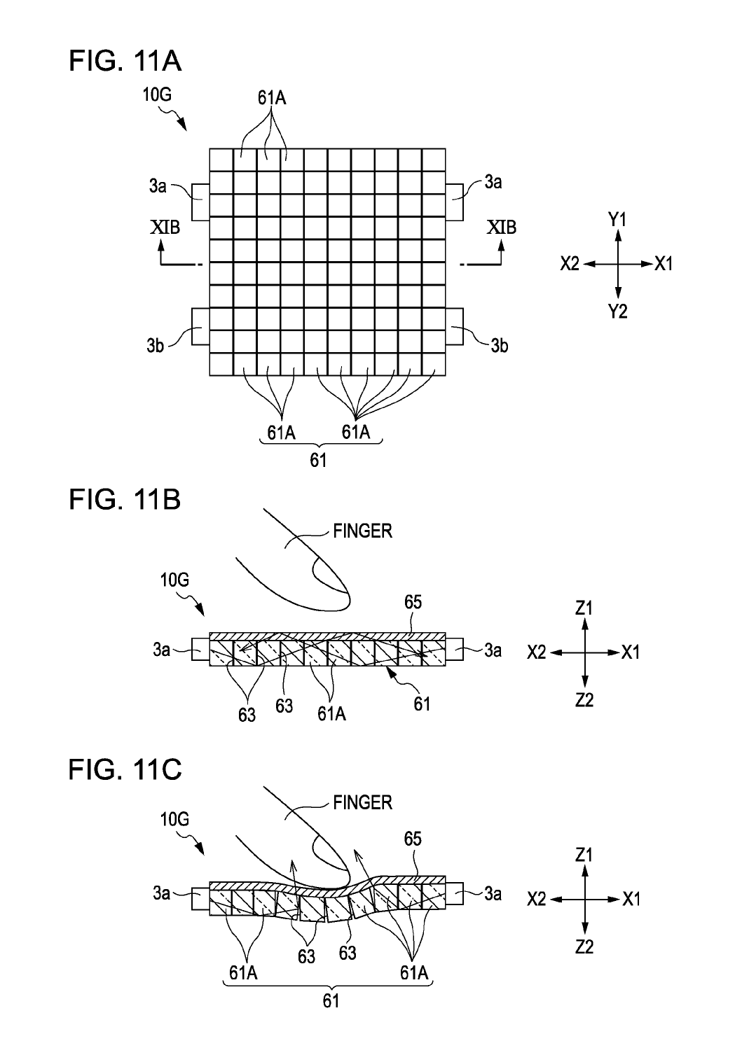

FIGS. 11A to 11C illustrate a display device according to a six embodiment of the present invention, FIG. 11A is a plan view showing the upper surface side of the planar light guide, FIG. 11B is a sectional view taken along line XIB-XIB in FIG. 11A, and FIG. 11C is a sectional view similar to FIG. 11B illustrating a state in which the planar light guide is in operation.

In a display device 10G illustrated in FIGS. 11A to 11C, a planar light guide 61 includes a plurality of square-shaped block pieces 61A that are arranged in a matrix pattern. The upper surfaces of the square-shaped block pieces 61A are connected to a transparent elastomer (elastic member) 65 using a transparent adhesive (not shown).

In the planar light guide 61 of the sixth embodiment, recesses 63 are formed (see FIG. 10C) at boundaries between adjacent square-shaped block pieces 61A.

The light sources 3a and the light sources 3b are disposed at sides of the display device 10G in the X directions. However, the display device 10G is different from the display devices of the above-described embodiments in that the display device 10G does not include X-direction driving mechanisms and Y-direction driving mechanisms.

Light emitted from the light sources 3a and the light sources 3b enters the planar light guide 61 through square-shaped block pieces 61A that are disposed at positions facing the light sources.

As illustrated in FIG. 11B, before the planar light guide 61 is deformed, the boundaries between adjacent square-shaped block pieces 61A are in contact states. Therefore, most of light that exits from one of the square-shaped block pieces 61A to the boundary directly enters adjacent one of the square-shaped block pieces 61A. The light propagates through the planar light guide 61 (a space between the square-shaped block pieces 61A) while repeatedly undergoing total internal reflection between the upper surfaces and the lower surfaces of the square-shaped block pieces 6

As illustrated in FIG. 11, with the display device 10G of the sixth embodiment, a user can press the upper surface of the planar light guide 61 with his/her finger or the like, so that the planar light guide 61 can be partially deformed in accordance with the pressing force.

When the upper surface of the planar light guide 61 is pressed and the planar light guide 61 is deformed so as to have a concave shape, recesses 63 are formed in the pressed portion at boundaries between adjacent square-shaped block pieces 61A. Thus, at the deformed portions, most of light can be reflected by side surfaces of the square-shaped block pieces 61A, which form the recesses 63, in the Z1 direction toward the upper surface side. Light that is incident on the upper surface of the planar light guide 61 (square-shaped block piece 61A) at an angle of incidence smaller than the critical angle of total internal reflection is emitted to the outside through the upper surface. Therefore, the upper surface side of the planar light guide 61, in particular, the area surrounding a fingertip that applies a pressing force can perform surface emission of light with a higher brightness.

Thus, the planar light guide 61 of the sixth embodiment can perform surface emission of light at the pressed position. Moreover, when a user moves his/her finger that presses the planar light guide 61, the position at which surface emission of light is performed can be moved accordingly. Therefore, by using the planar light guide 61, for example, in keyboard of a computer or a mobile phone, a key that a user pressed can emit light. By using the planar light guide 61, for example, in keys of an electric piano, the keys can emit light in accordance with the performance of a player.

In the embodiments described above, a dispersion reflecting surface is disposes at a position facing the lower surface of the planar light guide. However, the present invention is not limited thereto. The lower surface side can perform surface emission of light by disposing the dispersion reflecting surface at a position facing the upper surface.

Instead of using a dispersion reflecting surface, an advantage similar to that of the dispersion reflecting surface can be obtained by disposing a backlight that serves as the second light source at a position facing the upper or the lower surface.

What is claimed is:

1. A planar light guide for guiding light and performing surface emission of light, the planar light guide being made of a transparent resin, the planar light guide comprising:
a recess for outputting light therefrom, the recess being formed at least in one of first and second surfaces of the light guide,
wherein the recess can be changed between an open state, a closed state, and an intermediate state by deforming the light guide, and
wherein a position from which light is output, an amount of light, or a direction of light is changed in accordance with the deformation.

2. The planar light guide according to claim 1,
wherein the position from which light is output, the amount of light, or the direction of light is changed by pulling at least one of ends of the light guide or by bending the light guide.

3. The planar light guide according to claim 1,
wherein a depth dimension of the recess is smaller than a thickness dimension of the light guide.

4. The planar light guide according to claim 1,
wherein the recess is formed as a plurality of slits.

5. The planar light guide according to claim 1,
wherein the recess is formed in the first and second surfaces of the light guide, and
wherein a longitudinal dimension of the recess formed in the first surface and a longitudinal dimension of the recess formed in the second surface extend perpendicular to each other.

6. The planar light guide according to claim 1,
wherein a longitudinal dimension of the recess formed in an end portion of the light guide is different from a longitudinal dimension of the recess formed in a middle portion of the light guide.

7. The planar light guide according to claim 1,
wherein a depth dimension of the recess formed in an end portion of the light guide is different from a depth dimension of the recess formed in a middle portion of the light guide.

8. The planar light guide according to claim 1,
wherein the light guide includes a plurality of block pieces, the block pieces being connected to each other with a transparent elastic member, and
wherein the recess is formed between adjacent block pieces.

9. A display device comprising:
a planar light guide according to claim 1;
a light source for providing light to the light guide; and
a reflecting surface disposed at a position facing one of the first and second surfaces of the light guide, the recess not being formed in the one of the first and second surfaces.

10. A display device comprising:
a planar light guide according to claim 1;
a first light source for providing light to the light guide; and
a second light source disposed at a position facing one of the first and second surfaces of the light guide, the recess not being formed in the one of the first and second surfaces.

11. A display device comprising:
a planar light guide according to claim 9; and
a drive mechanism for deforming the light guide by bending or pulling the light guide.

12. A display device comprising:
a planar light guide according to claim 9,
wherein a character, a figure, a symbol, or a pattern is formed with the recess on the first and second surfaces of the light guide.
